(19) United States
(12) Patent Application Publication
(10) Pub. No.: US 2013/0191268 A1
(43) Pub. Date: Jul. 25, 2013

(54) SYSTEM, METHOD, AND REPO DERIVATIVE FINANCIAL INSTRUMENT AND MARKET FOR CONDUCTING REPO SWAP/CFD TRANSACTIONS

(71) Applicant: Scott E.D. SKYRM, New Canaan, CT (US)

(72) Inventor: Scott E.D. SKYRM, New Canaan, CT (US)

(21) Appl. No.: 13/793,106

(22) Filed: Mar. 11, 2013

Related U.S. Application Data
(63) Continuation-in-part of application No. 12/248,228, filed on Oct. 9, 2008.
(60) Provisional application No. 60/979,488, filed on Oct. 12, 2007.

(51) Int. Cl. G06Q 40/04

(52) U.S. Cl. CPC G06Q 40/04
USPC 705/37

(57) ABSTRACT

A system and method for facilitating a “swap” between the floating and fixed rate markets or any contract derivative based on floating repo rates (i.e. futures), and a financial instrument and a market for trading such instruments, based on such transactions. The basis of this new swap/contract is to establish a fixed rate versus floating rate “swap” in the repo market. The floating rate is generally the daily broker averages, but the floating rate could be a quarterly or monthly rate or semi-annual or annual. Quarterly or monthly “floaters” will be more popular in general collateral SWAP/CFD trades.

### CROSS-REFERENCE TO RELATED APPLICATIONS

This application is a continuation-in-part of U.S. Non-Provisional patent application Ser. No. 12/248,228, filed Oct. 9, 2008, which claims the benefit of U.S. Provisional Patent Application Ser. No. 60/979,488 filed Oct. 12, 2007, both of which are incorporated herein by reference. U.S. patent application Ser. No. 12/237,089, filed Sep. 24, 2008, and U.S. Provisional Patent Application Ser. No. 60/974,902, filed Sep. 25, 2007 are also incorporated herein by reference.

### TECHNICAL FIELD

The present invention relates generally to market systems and transaction methods for trading financial securities; and more particularly to a system and method of for facilitating a “swap” between the floating and fixed rate markets and other transactions derived from a repo floating rate (i.e. futures).

### BACKGROUND

The Repo and Reverse-Repo market also called the repurchase and reverse-repurchase market (herein called the “Repo Market” or “repurchase market”) is one of the largest traded fixed income markets in the world. The repo market refers to the market for repurchase agreement financial transactions. In a repurchase agreement, a security is sold and the seller agrees to buy back the security at a specified price and at a future date. The opposite is a reverse-repurchase agreement where a security is purchased with the agreement sell back the security at a specified price at a future date. In effect, a repurchase agreement is a collateralized loan, in that the security serves as collateral for borrowing cash. The interest rate for the repo transaction is established by the difference in the purchase and sale prices. Repo rates are unique interest rates where they are collateralized loans, yet are booked and sales and purchases and that makes them collateralized lending interest rates.

Banks, broker-dealers and other investors use the repo market to invest cash and finance securities. Repo trades represent one of the least expensive ways of financing because each transaction is a collateralized loan.

As a result of the growth of the repo market, a “screen based” trading system has developed over the years. Brokers (“IDBs” or Inter-Dealer Brokers) act as intermediaries for broker-dealers, banks and other investors. The brokers offer repo transactions traded on computer screens (via direct voice line or internet), repo transations can be either overnight or term.

### Overnight and Term Markets

An overnight trade is just for one day, and the vast majority of repo transactions are overnight. A term trade can be from two days extending out to a couple of years. But most term trades have maturities within six months.

### SUMMARY

Embodiments of the present invention provide a system, method and computer program product for conducting a REPO SWAP/CFD financial transaction on an electronic trading system.

An exemplary embodiment includes a method for conducting a REPO SWAP/CFD financial transaction on an electronic trading system on a computer system. The method is embodied in a computer program product for execution on an instruction processing system, comprising a tangible storage medium readable by the instruction processing system is storing instructions for execution by the instruction processing system. The method includes using the instruction processing system to identify a fixed rate for a repo market transaction and identifying by the instruction processing system a variable rate for a repo market transaction, the variable rate derived from a weighted average of collateralized repo trades in the market. The method further includes calculating by the instruction processing system a difference between the fixed rate and the variable rate using the at least one computer processor, and outputting data for display on a user interface from the at least one computer processor representing an amount to be exchanged based on the determined difference by the instruction processing system, between parties to the transaction.

Another exemplary embodiment includes a method for conducting a REPO SWAP/CFD financial transaction embodied in a computer program product for execution on an instruction processing system, comprising a tangible storage medium readable by the instruction processing system and storing instructions for execution by the instruction processing system for performing the method. The method includes receiving input data representing at least one fixed rate for collateralized trades on the repo market versus and at least one floating rate for collateralized trades on the repo market swap instrument in the repo market into the instruction processing system. The method further includes processing the data using the instruction processing system to determine a weighted market average floating rate for collateralized trades in the repo market and establish a swap between floating and fixed rate repo markets or other derivative contract based on floating repo rates (i.e. futures), and outputting a result from the instruction processing system to a user interface representing the established swap.

Another exemplary embodiment includes a system for an electronic trading system for conducting a REPO SWAP/CFD transaction. Briefly described in terms of architecture, one embodiment of the system, among others, is implemented as follows: The system includes a tangible storage medium readable by the computer system and storing instructions for execution at least one computer processor. The system further includes a subsystem executed by the at least one computer processor for establishing a contract to pay the difference between a fixed rate for collateralized trades on the repo market and an a weighted market average of floating rates for collateralized trades in the repo market for the life of a trade or any other contract based on floating repo rates (i.e. futures), and outputting data representing the established contract to a user interface.

Another exemplary embodiment includes a system for an electronic trading system for conducting a plurality of SWAP/CFD transactions. Briefly described in terms of architecture, one embodiment of the system, among others, is implemented as follows: The system includes a tangible storage medium readable by the computer system and storing instructions for execution by at least one computer processor. The system further includes a subsystem executed by the at least one computer processor to establish an online network for identifying cash flows and contract rates of at least one SWAP/CFD transaction, based on a fixed rate for collateralized trades in the repo market and/or a weighted market average of floating rates for collateralized trades in the repo market, and outputting data representing the cash flows and contract rates to a user interface.

Another exemplary embodiment includes a system for an electronic trading system for determining a value of a financial instrument comprising a repo market SWAP/CFD. Briefly described in terms of architecture, one embodiment of the system, among others, is implemented as follows: The system includes a tangible storage medium readable by the computer system and storing instructions for execution by at least one computer processor. The system further includes a subsystem executed by the at least one computer processor for determining a value of a financial instrument comprising a repo market SWAP/CFD, and providing a return based on a differential between a fixed term repo rate for collateralized trades in the repo market and a weighted market average floating repo rate for collateralized trades in the repo market or based on just the floating repo rate (i.e. futures), and outputting data representing the value of the financial instrument to a user interface.

Another exemplary embodiment includes a system for an electronic trading system for determining a value of a financial instrument. Briefly described in terms of architecture, one embodiment of the system, among others, is implemented as follows: The system includes a tangible storage medium readable by the computer system and storing instructions for execution by at least one computer processor. The system further includes a subsystem executed by the at least one computer processor to determine a value based on a difference between a fixed value amount for a collateralized trade in the repo market for a repo market transaction and a weighted market average variable value amount for a collateralized trade in the repo market for a repo market transaction, and outputting data representing the determined value to a user interface.

Another exemplary embodiment includes a system for an electronic trading system for determining a value of a financial instrument comprising a derivative based on a repo market transaction on a computer system. Briefly described in terms of architecture, one embodiment of the system, among others, is implemented as follows: The system includes a tangible storage medium readable by the computer system and storing instructions for execution by the computer system. The system further includes a subsystem executed by the computer. The subsystem including means for determining a value of a financial instrument comprising a derivative based on a collateralized transaction in the repo market for a repo market transaction, and means for outputting data representing the determined value to a user interface.

These and other aspects, features and advantages of the invention will be understood with reference to the detailed description herein, and will be realized by means of the various elements and combinations particularly pointed out in the appended claims. It is to be understood that both the foregoing general description and the following detailed description of the invention are exemplary and explanatory of preferred embodiments of the invention, and are not restrictive of the invention, as claimed.

### BRIEF DESCRIPTION OF THE DRAWING FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the repo swap services system of the present invention.

FIG. 2A is a block diagram illustrating an example of a server utilizing the repo swap services system of the present invention, as shown in FIG. 1.

FIG. 2B is a block diagram illustrating an example of a remote device utilizing the repo swap services system, as shown in FIG. 1.

FIG. 3 is a flow chart illustrating an example of the operation of the repo swap services system for the host of the present invention utilized by the server, as shown in FIGS. 2A.

FIG. 4 is a flow chart illustrating an example of the operation of the participant sign-in process on the server that is utilized in repo swap services system of the present invention, as shown in FIGS. 2A-3.

FIG. 5 is a flow chart illustrating an example of the operation of the display details of the market process 140 on the server that is utilized in repo swap services system 100 of the present invention, as shown in FIGS. 2A-3.

FIG. 6 is a flow chart illustrating an example of the operation of the placing orders process 160 on the server that is utilized in repo swap services system 100 of the present invention, as shown in FIGS. 2A-3.

FIG. 7 is a flow chart illustrating an example of the operation of the orders match process 180 on the server that is utilized in repo swap services system 100 of the present invention, as shown in FIGS. 2A-3.

FIG. 8 is a flow chart illustrating an example of the operation of the calculate broker average rate process on the server that is utilized in repo swap services system of the present invention, as shown in FIGS. 2A-3.

FIG. 9 is a flow chart illustrating an example of the operation of the settling the trade process on the server that is utilized in repo swap services system of the present invention, as shown in FIGS. 2A-3.

The detailed description explains the preferred embodiments of the invention, together with advantages and features, by way of example with reference to the drawings.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Fixed term rates in repo have existed for years, but with the advent of the TERM BAM trade, there is now a term “floating rate” repo trade. In example forms, the present invention provides a system and method for facilitating a “swap” between the floating and fixed rate markets or any contract based on floating repo rates (i.e. futures). The basis of this new swap/contract is to establish a fixed rate versus floating rate “swap” in the repo market. The floating rate is generally one or more of the daily broker averages for a type of security or collateral, but the floating rate could be a quarterly or monthly rate semi-annually or annual rates.

### The “Broker Average”

Brokers publish the weighted average each day for all the securities they trade. The averages are comprehensive of the morning's trading from 7:00 am to 10:00 am or anytime from the beginning of the trading day until the end of the day. By compiling the weighted averages for one or more brokers, it is possible to determine the “average” a security traded at during the main trading hours. One broker average rate can be determined after the 10:00 am averages are published by the Brokers, other averages could be published after 3:00 pm or at the end of the day. We take the weighted average of one or more electronic or voice repo broker screens or markets to determine the daily average, to establish the “floating rate.” As market participants execute orders through the IDB brokers for lending and borrowing securities in the repo market, those individual transactions will occur at one or more different repo interest rates. The average of each day's trading at any particular IDB broker is published by that broker and the total trade volume that traded. The BAM (Broker Average Market) or floating repo rate for the day is established by adding together one or more of the IDB broker averages and creating a weighted average based on any or all of the day's transactions included in the BAM or floating rate repo index. The BAM or floating rate repo index for the day can be based on one or more repo trades which trade through the IDB brokers. The BAM can be the weighted average from just one IDB broker or for more than one IDB broker. For example, if Broker A trades 100 million in General Collateral repo at an average rate of 4.75% and Broker B trades 100 million in General Collateral repo at an average rate of 4.77%, then the BAM COULD be just the IDB Broker A rate. If the BAM is the weighted average of Broker A and Broker B, then the BAM (floating rate repo rate) for the day is 4.76%.

In one aspect, the present invention is a method of conducting a repo swap/CFD financial transaction, said method comprising determining a fixed rate for a repo market transaction; determining a variable floating rate for a repo market transaction; determining a difference between the fixed rate and the variable rate; and exchanging an amount based on the difference, between parties to the transaction, or it can be any derivative contract based on the floating repo rate BAM (i.e. futures).

In another aspect, the invention is a method of conducting a financial transaction including swapping between floating and fixed rates by establishing a fixed rate versus floating rate swap transaction in the repo market. Optionally, the floating rate is based on one or more daily broker averages.

In another aspect, the invention is a system for conducting a REPO SWAP/CFD transaction, the system comprising establishing a contract to pay the difference between a fixed rate and an average of floating rates for the life of a trade or any derivative contract based on the floating repo rate BAM (i.e. futures).

In yet another aspect, the invention is an electronic trading system for conducting SWAP/CFD transactions, comprising identifying cash flows and contract rates of the SWAP/CFD, a fixed rate, and a weighted average of floating rates or any derivative contract based on the floating repo rate BAM (i.e. futures).

In another aspect, the invention is a financial instrument comprising a repo market SWAP/CFD providing a return based on a differential between a fixed term rate and a floating rate or any derivative contract based on the floating repo rate BAM (i.e. futures).

In another aspect, the invention is a market for carrying out transactions between parties of the above-described financial instrument.

In still another aspect, the invention is a financial instrument having a value determined by a difference between a fixed value amount for a repo market transaction and a variable value amount for a repo market transaction.

In yet another aspect, the invention is any financial instrument or derivative based on floating rate repo rates (i.e. futures).

In another aspect, the invention is a financial instrument comprising a derivative based on a repo market transaction.

In another aspect, the invention is a market for carrying out transactions between parties of any of the above described financial instruments.

In example forms, the present invention provides a system and method for conducting repo transactions at rates based on a daily or term weighted average rate—The BAM or floating repo rate

In one aspect, the present invention is a system for conducting repo market transactions, wherein the repo market transactions are made at a “Broker Average Market” or “BAM” rate based on an average transaction rate or daily or term floating repo floating rate

In example form, the system for conducting repo market transactions includes a computer network for identifying a plurality of repurchase and reverse-repurchase agreement transactions between sellers and buyers, each of the plurality of repurchase agreement transactions defining a transaction repo rate. The system further includes a processor for determining an average market rate based on the transaction repo rates of the plurality of repurchase agreement transactions, and a market for conducting repo market transactions at the determined average market rate.

In this aspect, the invention is a method for conducting repo market transactions, wherein the repo market transactions are made at a BAM rate based on the average transaction rate.

For example, the system and method of the invention may provide for transactions at a published or determined “Broker Average Market” or “BAM” rate, whereby two counter parties transact a trade at the broker average. One is the buyer of the security and one is the seller. The repo rate is determined by the weighted average of the transaction rates where that security trades in one or more of the brokers' markets that day.

Since the invention provides that the BAM can be traded in itself, market participants can bid/offer at a flat spread (+/−0) or a spread to the broker average. A trade done at +1 means the rate will be the broker average plus one basis point. The broker average rate is determined after the 10:00 am, or other set time, averages are published by the brokers or repo transactions which trade in the brokers' markets.

A term BAM trade is at the average of the daily averages for more than one day. For example, for a two-day BAM term trade done “flat” (+/−zero basis points) to the average and the BAM overnight average is 4.75% the first day and 4.85% the second day, the repo rate on the two-day BAM trade would be 4.80%. (The sum of BAM overnight rates divided by number of days). If the trade was done at +1 then the BAM term rate would be 4.81%

In example form, the method of conducting repo market transactions includes establishing a repo market for conducting a plurality of repurchase agreement transactions between sellers and buyers of securities, each of the plurality of repurchase agreement transactions defining a transaction repo rate. The method preferably also includes determining an average market rate based on the transaction repo rates of the plurality of repurchase agreement transactions, and conducting a repo market transaction at the determined average market rate.

In still another aspect, the invention is a repurchase agreement or repo financial instrument wherein a seller sells a security to a buyer and the seller agrees to buy back the security at a price and a date established prior to the sale. The price preferably includes interest based on a broker average market rate, and the security serves as collateral for the repurchase agreement.

In another aspect, the invention is a computer network for conducting repo market transactions, wherein the repo market transactions are made at a BAM rate based on an average transaction rate.

In another aspect, the invention is a computer readable media or memory element comprising computer executable software for conducting repo market transactions, wherein the repo market transactions are made at a BAM rate based on an average transaction rate.

In yet another aspect, the invention is a market for conducting repurchase agreement transactions wherein a seller sells a security to a buyer and the seller agrees to buy back the security at a price and a date established prior to the sale. The price includes interest based on a determined average market rate, and the security serves as collateral for the repurchase agreement.

In alternate forms of the invention, overnight or term repo trades can be conducted at rates based on published or calculated measures other than the broker average, and/or the system and method of the invention can be applied to financial markets other than the repo market. Also, the invention includes both the methods of conducting trades described herein, as well as systems and markets established for carrying out such methods. The system and method of the invention can be carried out in tandem with other transactions in existing financial markets, and/or in separately established markets.

The present invention provides a system and method for carrying out a REPO SWAP/CFD transaction. A SWAP/CFD is an agreement between two parties to exchange the difference between two collateralized interest rates at the end of the contract. The REPO SWAP/CFD was created to allow counter parties the benefits of taking a position, assuming interest rate risk, in the repo market without having to physically settle any securities. Counter parties to the transaction are able to assume repo interest rate risk in collateralized loan transactions. Securities do not change hands. A REPO SWAP is an OTC agreement or exchange traded contracts to pay the difference between the fixed and floating rates for a specified period of term of the trade. The invention further includes a financial instrument or security based on the disclosed methods, derivative financial instruments based thereon, as well as a market (physical, electronic or otherwise) for carrying out transactions according to the disclosed methods and/or trading said financial instruments.

A REPO SWAP/CFD can be booked either as a traditional SWAP or as a CFD. A CFD is a “Contract For Difference,” or an exchange traded futures contract. A REPO SWAP/CFD is a contract to pay the difference between the fixed rate and the average of the floating rates for the life of the trade or contact based on floating repo rates. It is traded Over-the-Counter (OTC) or exchange and is booked like any OTC fixed income product or exchange traded product.

In example forms of the invention, there are no settlement costs, balance sheet implications, fails, or capital charges for a REPO SWAP/CFD. If a trader wanted to speculate between the difference between term fixed and term floating rates, there is no need to actually book two separate trades. The REPO SWAP/CFD allows the trader to assume risk without settling the actual securities, or any contract derived from floating repo rates.

For example, if a trader believes the current U.S. Treasury 10 Year Note will become more special (the repo rate will decline) in the next couple of days, that trader can BUY the U.S. Treasury 10 Year Note SWAP/CFD for a one week term. The trader now owns the performance of the security for one week at a fixed rate, and is short at the floating rate. The trader generates income when the overnight rates average lower than the fixed term rate. The trader would lose money if the average floating rates for the week were higher than the term fixed rate.

### Documentation

In example forms of the invention, counter parties will sign or otherwise enter into a SWAP/CFD ISDA (International Swaps And Derivatives Association) agreement, Master Repurchase Agreement (MRA), and/or futures agreement. The agreement specifies the obligations of both counter parties and the terms of the contract. The agreement can be created as an addendum to the Master Repurchase Agreement or as a separate agreement. The addendum and/or agreement will specify: payments, day count, calculated interest and settlement amounts, etc. Margin calls will follow the rules outlined in the agreements.

### Reference Value/Price Multiplier

The contract's “reference value” is the equivalent of the “principal amount” for a regular repo trade. The “price multiplier” is the equivalent of the “dirty price,” or price of the underlying security plus accrued interest, as is the market convention for pricing the underlying securities for repo trades.

The REPO SWAP/CFD can be automatically re-priced each day if the underlying instrument is a specific security, like the current US Treasury 10 Year Note. The Electronic Trading System will re-calculate the contract's reference value (principal amount) daily. So in the case of a coupon payment or market movement, the contract is automatically re-priced. The Electronic Trading System will calculate interest differentials based on the “reference value” calculated on a daily basis.

If the underlying security in the contract is not a specific security, for example the repo swap/CFD is based on a form of General Collateral, then the underlying securities need not be repriced each day to represent changes in the underlying securities since there is no specific security, then the underlying securities (collateral) price will always remain at par or 100.00.

### Example Contract Specifications

Contract Size: One REPO SWAP/CFD is equal to $1 million notional value of the underlying security. Though different denominations can be negotiated by counter parties

Underlying Securities (collateral): U.S. Treasurys, TIPS, Agencys, Agency Mortgage Backed Securities, Asset-Backed Securities, General Collateral, Corporate bonds, and Equities. General Collateral can be considered all form traded in the market including “General Collateral Bonds”, “General Collateral Notes/Bills,” “General Collateral GCF”, GCF, etc.

Floating Rate: The “floating rate” or BAM for Treasurys is defined as the weighted average of one or more electronic or voice brokers' daily averages. Other Underlying Securities rates can be defined as well within the scope of the invention. The repo transactions can be conducted at rates based on a daily or term weighted average rate. For example, it may provide for transactions at a published or determined “Broker Average Market” or “BAM” rate, whereby two counter parties transact a trade at the broker average. One is the buyer of the security and one is the seller. The repo rate is determined by the weighted average of the transaction rates where that security trades in one or more of the brokers' markets that day.

In alternate forms of the invention, overnight or term trades can be conducted at rates based on published or calculated measures other than the broker average, and/or the system and method of the invention can be applied to financial markets other than the repo market. The system and method of the invention can be carried out in tandem with other transactions in existing financial markets, and/or in separately established markets.

Confirms: Confirms are sent out daily, as per regulations or agreements between counter parties. Trade details and interest accruals can be monitored on the electronic trading system online.

Delivery: No delivery of physical securities, contracts are settled in cash.

Tick Size: 1 tick equals 1 basis point, though partial basis point trades are allowed if agreed upon by parties involved

Price Quote: Quoted as an interest rate. The term fixed rate is stated and the floating rate is determined daily by the “broker average.”

Contract Months: OTC (Over-the-Counter) or January, February, March, April, May, June, July, August, September, October, November, December—or any specific dates are acceptable.

Trading Hours: 2:00 am New York time to 2:30 pm New York time for CASH (same day settlement), 2:00 am New York time to 4:30 pm New York time for REG (T+1 or transaction date plus one day) and SPOT (T+2) settle, though trading hours can be based on and adjusted to the market, time zone, and trading of the underlying securities or related exchange products.

Ticker Symbol: REPOIS (subject to change).

Daily Price Limit: None.

Margin Information: Margining specified in MRA or ISDA agreements. Margin calls at $500,000 as per agreed upon in counter party's agreements.

Settling Contract Values: Contract cash flows/differences and settled after the day of expiration.

### Booking Trades

The Electronic Trading System keeps track of all outstanding SWAP/CFD's. In the Executions Window, a section named Outstanding trades (shown in example form below) shows the cash flows and contract rates of the SWAP/CFD. One column shows the fixed rate, another column shows the weighted average of floating rates. The last column shows the current cash flows of the trade. The Electronic Trading System will automatically send confirms to any requested recipients. The electronic trading system preferably comprises one or more computers accessible by one or more users, optionally via a communications network, for carrying out transactions, determining and/or recording transaction data, reporting, etc. Traders and back-office personnel will have daily online access to interest accruals on contract settlement payments.

Outstanding Trades

| | | | Today's | BAM | | Today's | Net Cash |
|---|---|---|---|---|---|---|---|
| | | Term | BAM | Average | # of | Price | Flow of |
| SWAP/CFD | Term | Rate | Rate | To Date | Contracts | Multiplier | Contract |
| UST 10 Year | Dec 31 | 4.75% | 4.70% | 4.657% | 100 | 102.375 | $1,547.00 |

BUYING the SWAP/CFD is the equivalent of going LONG the security in the repo term market. BUYING (borrowing) the SWAP/CFD means the buyer is receiving a fixed rate on cash and paying the floating rate on cash. SELLING (lending) the SWAP/CFD is the equivalent of SELLING the security in the repo term market. Selling the SWAP/CFD means the seller is paying a fixed rate on cash and receiving the floating rate. The cash flows reflect the normal structure of the repo market. Overall, the BUYER wants overnight rates to average lower than the fixed rate and the SELLER wants overnight rates to average higher.

### Example of Market Quote: 10 Year Note—1 Week SWAP/CFD—4.80%/4.75%

Suppose the 1 week fixed term repo rate is 4.75% and assume the underlying U.S. Treasury 10 Year Note underlying price is trading at 100, including accrued interest. A trader who buys the REPO SWAP/CFD will buy term (fixed) and sell floating. This means the investor invests cash (RECEIVES) a 4.75% fixed rate for the life of the trade and borrows cash (PAYS) at the floating rate each day.

### Cash Flows

BUY: 1 WEEK REPO SWAP/CFD—Trader is long the 1 week security and short the 1 week BAM—The trader is “LONG” the market.

The Cash Flow Formula is:

Number of contracts*“reference value”*rate*# of days/360.

The “reference value” of the contract is the price+accrued interest of the underlying security divided by 100.

Truncation: For interest rates, all numbers after the 6^{th} decimal place are dropped. For prices and cash, all numbers after the 2^{nd} decimal place are dropped. For example, 4.657142 is a valid interest rate and if the rate was 4.6571428, then the 8 in the 7^{th} decimal place would be dropped. For prices and cash, 1,805.58 is cal valid number, if the number were 1,805.583 then the 3 in the 3^{rd} decimal place would be dropped.

TERM Interest Cash Flows:

100 million 4.75% for 7 days=100,000,000*(100)*0.0475*7/360=$92,361.11

BAM Interest Cash Flows:

100 million*(100)*(4.75%,4.65%,4.55%,4.55%4.70%(3 days on Friday))[average rate is 4.657142]/360=$90,555.53

SWAP/CFD value at the end of the contract is $1,805.58

The buyer of the REPO SWAP/CFD receives $1,805.58. The seller of the REPO SWAP/CFD pays $1805.58.

### Additional Features and Advantages:

Minimal Transaction Costs—Traders can speculate on the direction of the repo market or individual securities without settling securities. There is no balance sheet usage, clearing securities, and with no risk of fails.

Substitute For Term Repo—Traders no longer need to lock-in term repo trades. If a trader wants to lock-in the term repo rate, a trader can take a long or short SWAP/CFD position.

New Product—It's a new tool to trade in the repo market, offering additional products for clients.

Interest Rate Hedge—Traders can hedge in the Term general collateral or any term collateralized interest rate risk, without having to repo or reverse-repo the security term to another institution.

Reduced Costs of Hedging Risk—Hedge Funds can lock-in term rates without the costs involved with a prime broker. A trader at a hedge fund must consider added costs of repo execution for trading decisions. Prime brokers charge several basis points for term trades and additional basis points to close the position. With the REPO SWAP/CFD, the trader only pays the bid or offer in the REPO SWAPS/CFD market.

Arbitrage—Traders can arbitrage the REPO SWAP/CFD market versus the traditional term repo market.

Added Leverage—traders can leverage their collateralized interest rate risk without increasing balance sheet usage.

### Trading Examples

Basis Trade—A basis trader is LONG the BASIS (long the security and short the futures contract). The trader can normally lock-in funding costs only in the term repo market. In the past, the trader is forced to pay a bid/offer spread in the term repo market, transaction costs, and lose control of the securities before the futures contract delivery. If the trader gets out of the cash position, he/she must unwind the repo trade. Instead, the same trader can SELL the security to the delivery date as a REPO SWAP/CFD. The trader continues to finance the positions daily, but has a fixed repo rate locked-in until delivery. If he/she chooses to close the position, he/she only needs to unwind the REPO SWAP/CFD and there are no balance sheet implications.

Better Hedge For Term General Collateral—A trader who hedges term general collateral or short coupons with Fed Funds futures contracts will have a better hedge. The hedge is no longer susceptible to movements in the spread between G.C. and fed funds, which can be volatile.

Shorting Term General Collateral—Traders never had a good way to short sell term general collateral. There was always this bias in the market. It is easy to go LONG, but difficult to go SHORT. Getting SHORT means selling a specific U.S. Treasury security issue in the term markets. If you do not own that specific security, you need to borrow that specific security each day and pay a premium for the specific security. The repo market invented the General Collateral GCF trade several years ago to address this. However, GCF term trades trade at a discount, higher rate that equivalent General Collateral rates, sometimes as much as 2 basis points. A trader can SELL a G.C. SWAP/CFD and effectively get short term, while receiving the daily floating rate.

Substitutions In Term G.C.—When traders trade Term G.C., they generally must allow collateral substitutions. The G.C. SWAP/CFD does not require any substitutions.

Hedge Structured Repo—Structured Repo trades involve General Collateral (G.C.) trades which reset rates at certain times or under certain events. Instead of hedging these trades with futures and/or options, repo traders can hedge with G.C. SWAP/CFD's. This generates a better hedge.

Term Corporate Bonds/Equities—Many Corporate bond repo traders charge large premiums to sell Corporates/Equities term for fear of buy-ins. A SWAP/CFD is not affected by buy-ins. It is the difference between a floating rate (daily) and the term rate and settlement issues do not affect it.

CDS—CDS (Credit Default Swaps) traders can more easily arbitrage swaps versus cash bonds with no balance sheet implications by locking in funding costs for specific corporate bonds or equities.

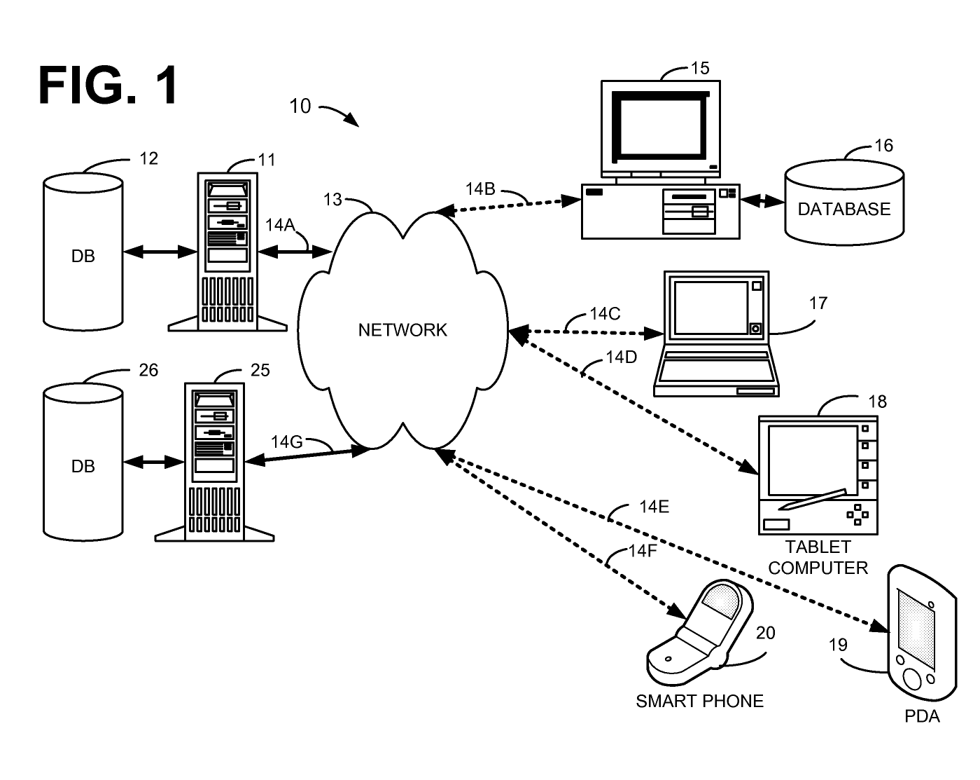

Referring now to the drawings, in which like numerals illustrate like elements throughout the several views. FIG. 1 illustrates an example of the basic components of a system 10 using the repo swap services system in connection with the preferred embodiment of the present invention. The system 10 includes a server 11 and the remote devices 15 and 17-20 that utilize repo swap services system of the present invention.

Each of the remote devices 15, 17-20 has applications and can have a local database 16. Server 11 contains applications, and a database 12 that can be accessed by remote devices 15 and 17-20 via connections 14(A-F), respectively, over network 13. The server 11 runs administrative software for a computer network and controls access to itself and database 12. The remote devices 15 and 17-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization (i.e. a university, military base, sports stadiums, medical complex or the like).

The remote devices 15 and 17-20 may each be located at remote sites. Remote devices 15 and 17-20 include but are not limited to, PCs, workstations, laptops, handheld computers, smart phones, pocket PCs, PDAs, tablet computers, pagers, WAP devices, non-WAP devices, cell phones, palm devices, printing devices, and the like. Included with each of the remote devices 15 and 17-20 is an ability to process a repo swap transaction on network 13. On the remote devices 15 and 17-20 there is a printer for printing out a recording of the repo swap transaction. In remote devices 15 and 17-20, there is the ability for displaying the repo swap transaction on a display screen.

Thus, when a user at one of the remote devices 15 and 17-20 desires to access repo swap transaction status from the database 12 at the server 11, the remote devices 15 and 17-20 communicate over the network 13, to access the server 11 and database 12. A mobile printer (not shown) or and a stand-alone printer (not shown) provide for printing a recording of the repo swap transaction.

Third party vendors computer systems 25 and databases 26 can be accessed by repo swap services system 100 on server 11 in order to process repo swap transactions. Data that is obtained from third party vendors computer systems 25 and databases 26 can be stored on server 11 and database 12 in order to provide later access to the user on remote devices 15 and 17-20. It is also contemplated that for certain types of data that the remote devices 15 and 17-20 can access the third party vendors computer systems 25 and databases 26 directly using the network 13.

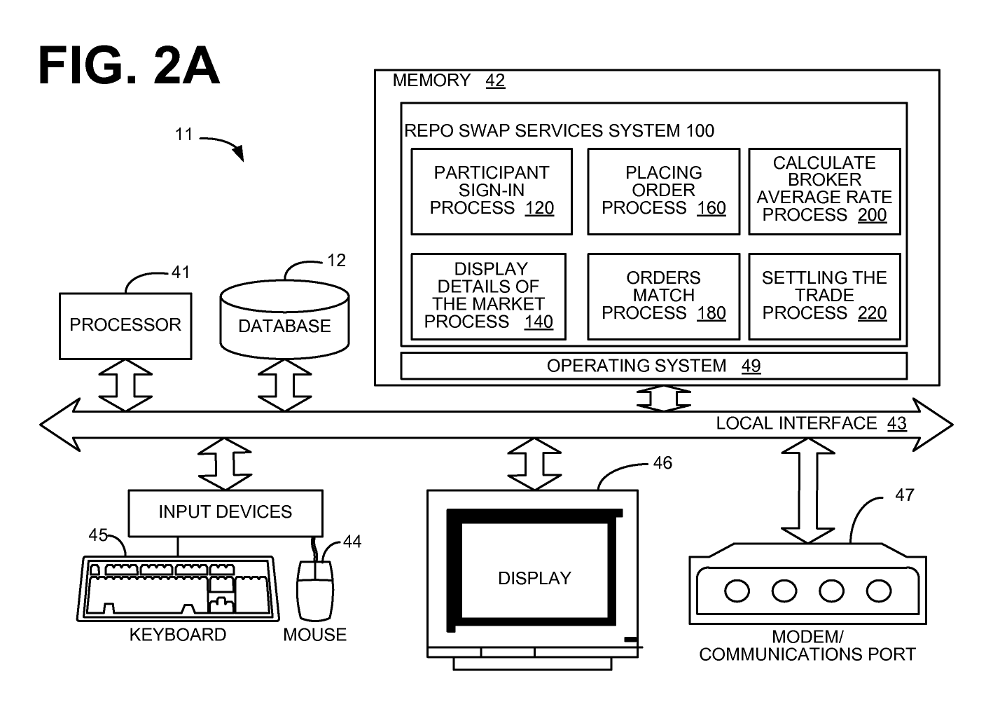

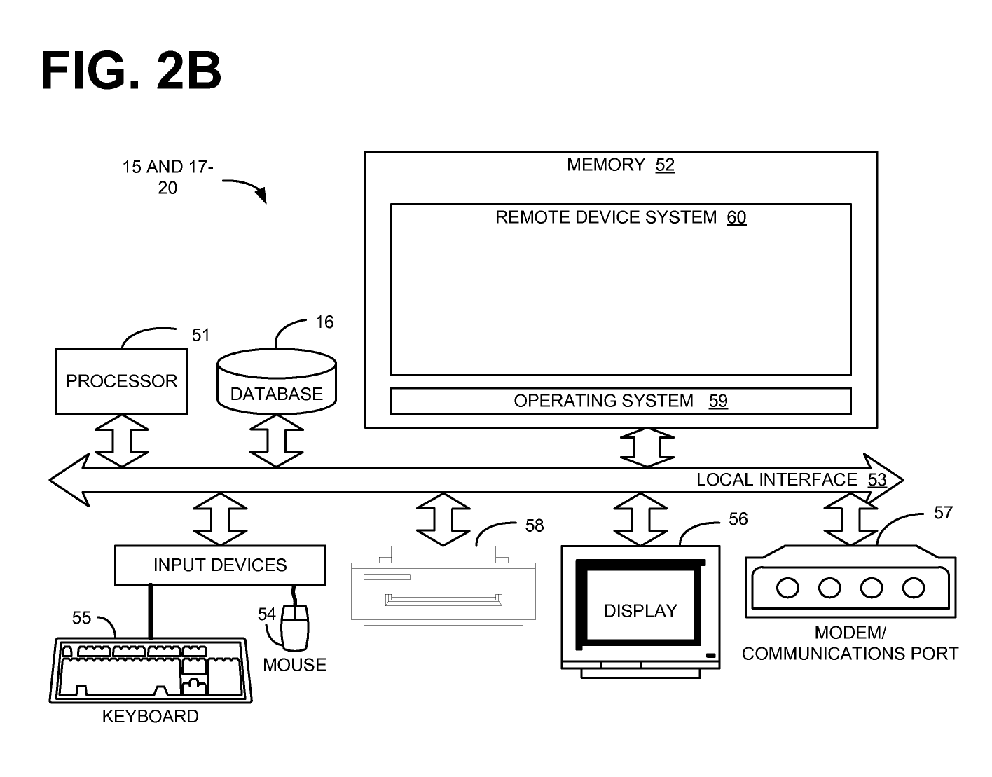

Illustrated in FIG. 2A is a block diagram demonstrating an example of server 11, as shown in FIG. 1, utilizing repo swap services system 100 of the present invention. Server 11 includes, but is not limited to, mainframes, PCs, workstations, laptops, PDAs, palm devices, smart phones and the like.

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and repo swap services system 100 of the present invention. As illustrated, repo swap services system 100 of the present invention comprises numerous functional components including, but not limited to, the participant sign-in process 120, display details of the market process 140, placing order process 160, orders match process 180, calculate broker average rate process 200, and settling the trade process 220.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as repo swap services system 100, and provides scheduling, input-output control, file and data management, memory management, and communication control and related services. However, it is contemplated by the inventors that repo swap services system 100 of the present invention is applicable on all other commercially available operating systems.

Repo swap services system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, repo swap services system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, assembler, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. Repo swap services system 100 and the O/S 49 are read, in whole or in part, by the processor 41, perhaps buffered within the processor 41, and then executed.

When repo swap services system 100 is implemented in software, as is shown in FIG. 2A, it should be noted that repo swap services system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a non-exhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where repo swap services system 100 is implemented in hardware, repo swap services system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. FIG. 2B is a block diagram illustrating an example of a remote device utilizing the remote device system 60 for the remote devices 15 and 17-20, as shown in FIG. 1. The remote devices 15 and 17-20 provide access to the repo swap services system 100 of the present invention on server 11 and database 12 using for example, but not limited to an Internet browser. The information accessed in server 11 and database 12 can be provided in the number of different forms including, but not limited to, ASCII data, WEB page data (i.e. HTML), XML or other type of formatted data. As illustrated, the remote devices 15 and 17-20 include many of the same components as server 11 described with regard to FIG. 2A. These components include processor 61, memory 62, local interface 63, mouse 64, keyboard/keypad 65, display 66, communication port 67 and operating system 69. One addition is printer 68. Hereinafter, the remote devices 15 and 17-20 are devices that will be referred to as remote devices 15 for the sake of brevity.

The remote device system 60 is located in memory 62 of the remote devices 15. When the remote device system 60 is implemented in software, as is shown in FIG. 2B, it can be stored on virtually any computer readable medium for use by or in connection with any computer related system or method. In an alternative embodiment, where the remote device system 60 is implemented in hardware, the remote device system 60 can be implemented in the same way as described above with regard to the remote device system 60 (FIG. 2B).

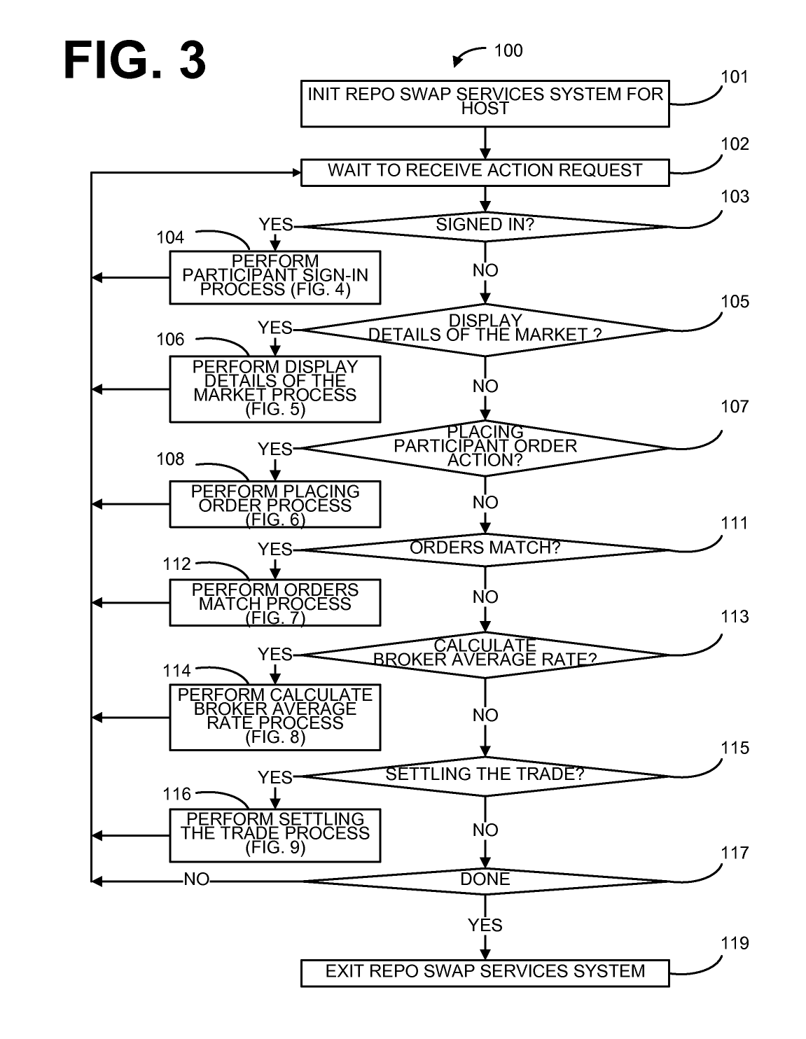

FIG. 3 is a flow chart illustrating an example of the operation of repo swap services system 100 of the present invention utilized by the server 11, as shown in FIG. 2. Repo swap services system 100 of the present invention provides a customer with the ability to purchase a contract for the difference between a floating rate and a fixed rate based on repo rates. The repo swap services system and method of the present invention also offers the customer a term “floating rate” repo trade.

First at step 101, repo swap services system 100 is initialized. This initialization includes the startup routines and processes embedded in the BIOS of the server 11. The initialization also includes the establishment of data values for particular data structures utilized in repo swap services system 100.

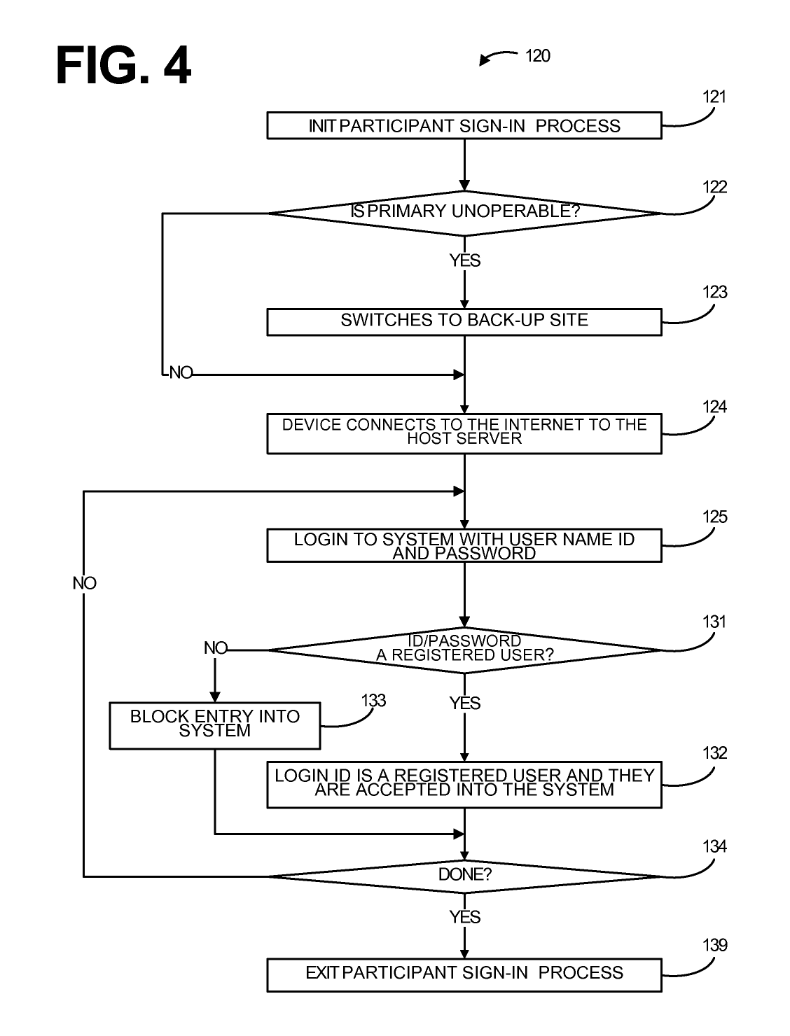

At step 102, repo swap services system 100 waits to receive an action request. Once an action is received at step 102, it is determined if the action is to provide participant sign-in to the repo swap services system 100 at step 103. If it is determined that the action is not to participant sign-in to the repo swap services system 100, then repo swap services system 100 skips to step 105. However, if it is determined in step 103 that a participant sign-in is to occur, then repo swap services system 100 performs the participant sign-in process at step 104. The participant sign-in process that is herein defined in further detail with regard to FIG. 4. After performing the participant sign-in process, the repo swap services system 100 returns to step 102.

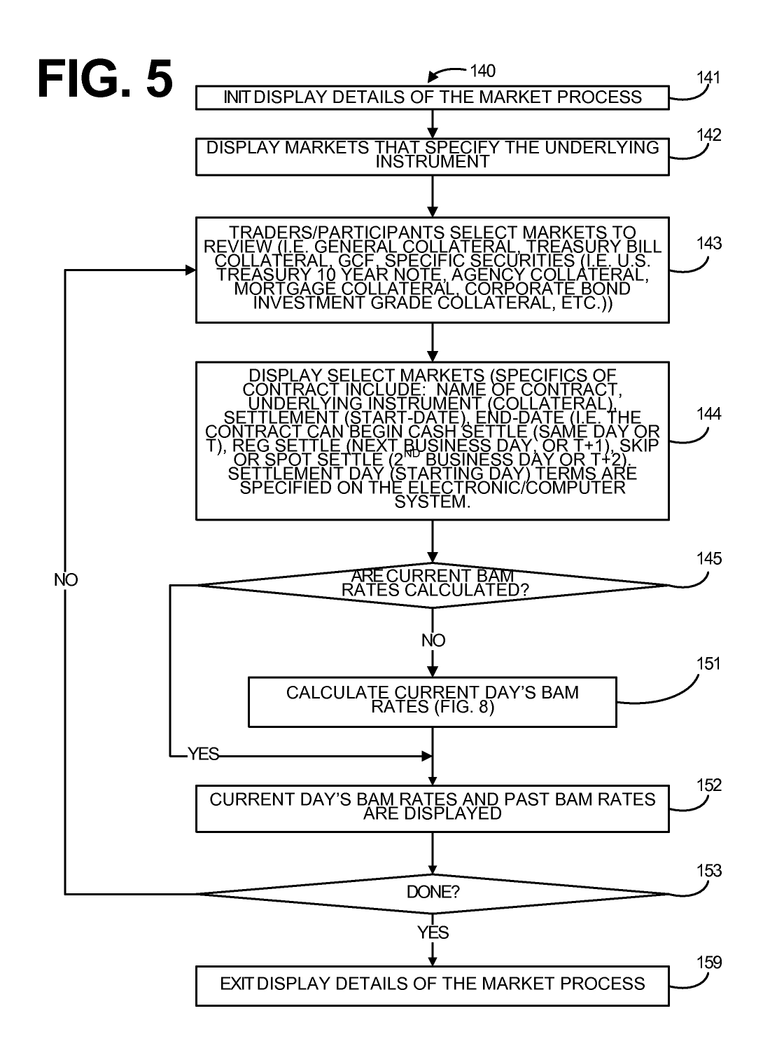

At step 105, it is determined if the action is to display details of the market action. If it is determined that the action is not a display details of the market action, then repo swap services system 100 skips to step 107. However, if it is determined in step 105 that the action is a display details of the market action, then repo swap services system 100 performs the display details of the market process at step 106. The display details of the market process is herein defined in further detail with regard to FIG. 5. After performing the display details of the market process, the repo swap services system 100 returns to step 102.

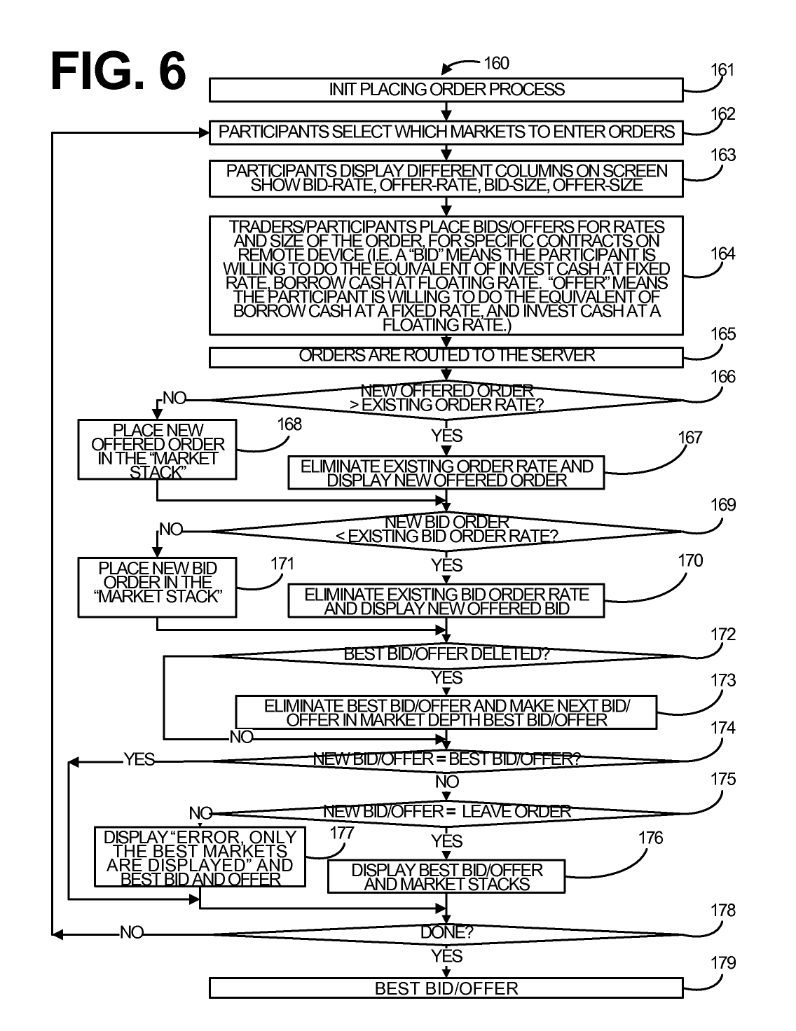

At step 107, it is determined if the action is a placing participant order action. If it is determined that the action is not a placing participant order action, then repo swap services system 100 skips to step 111. However, if it is determined in step 107 that the action is a placing participant order action, then repo swap services system 100 performs the a placing participant order process at step 108. The placing participant order process is herein defined in further detail with regard to FIG. 6. After performing the placing participant order process, the repo swap services system 100 returns to step 102.

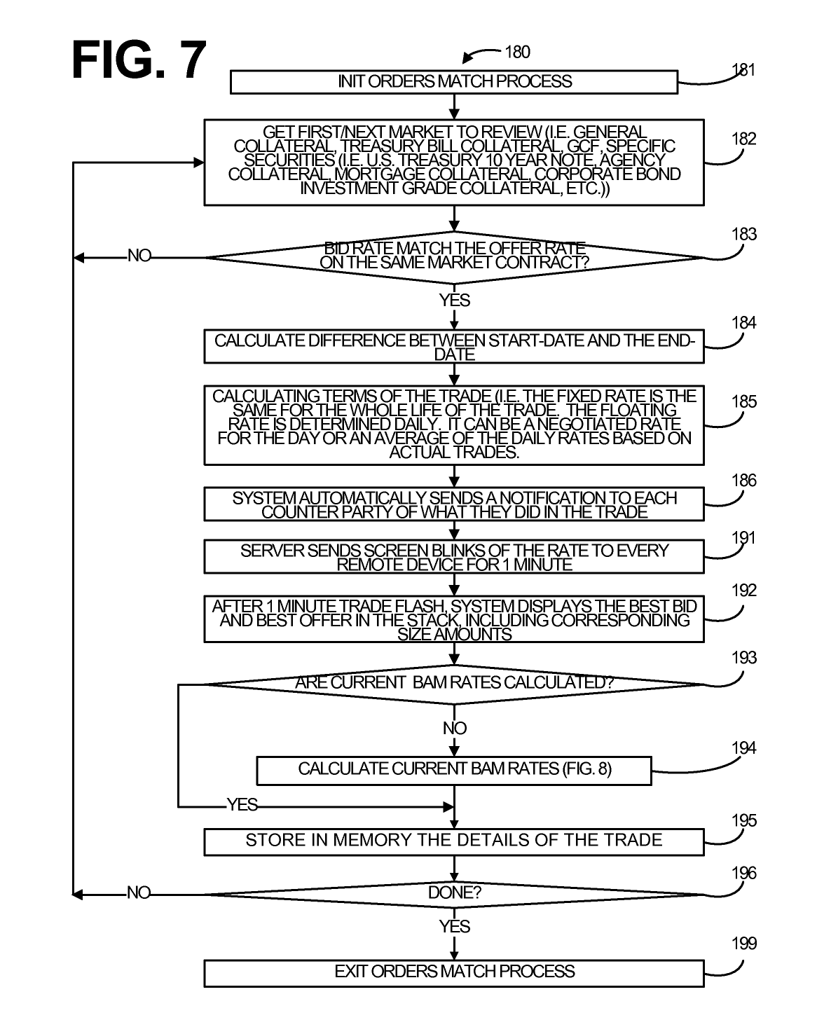

At step 111, it is determined if the action is an orders match action. If it is determined that the action is not an orders match action, then repo swap services system 100 skips to step 113. However, if it is determined in step 111 that it is an orders match action, then repo swap services system 100 performs the orders match rd process at step 112. The orders match process is herein defined in further detail with regard to FIG. 7. After performing the orders match process, the repo swap services system 100 returns to step 102.

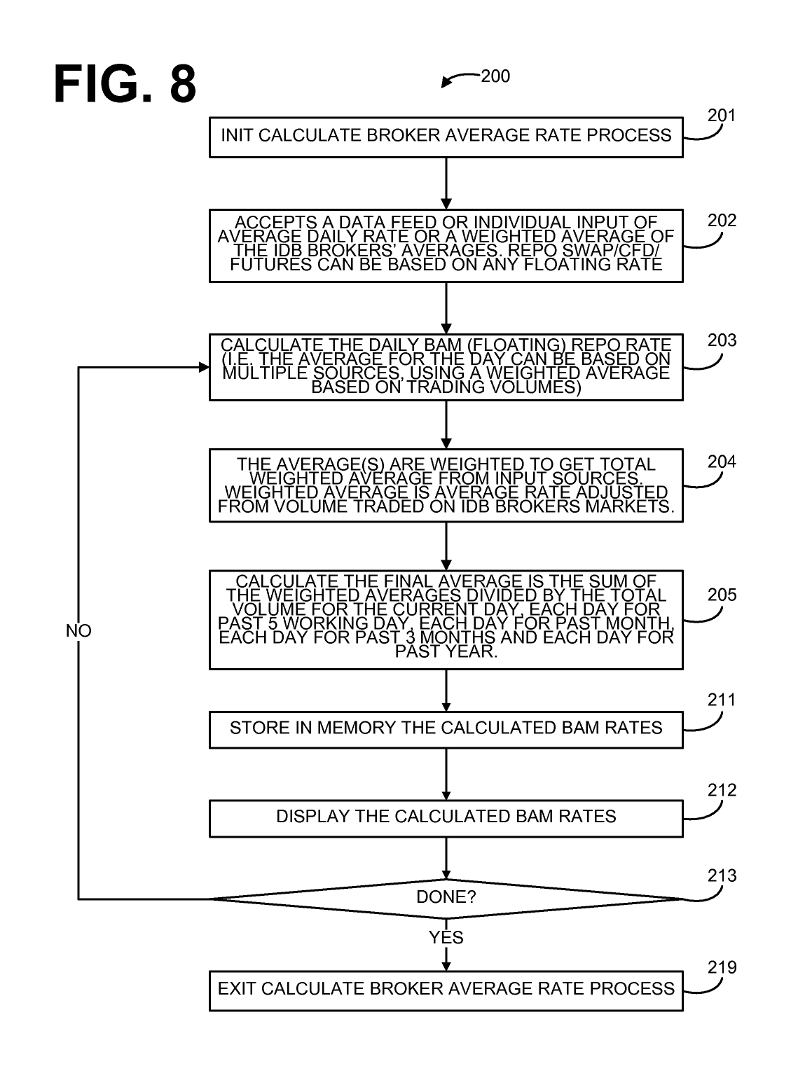

At step 113, it is determined if the action is a calculate broker average action. If it is determined that the action is not a calculate broker average action, then repo swap services system 100 skips to step 115. However, if it is determined in step 113 that it is a calculate broker average action, then repo swap services system 100 performs the calculate broker average process at step 114. The calculate broker average process is herein defined in further detail with regard to FIG. 8. After performing the calculate broker average process, the repo swap services system 100 returns to step 102. In an alternative embodiment, the broker weighted averages can be inputted into the system from an outside source or received via direct computer contact.

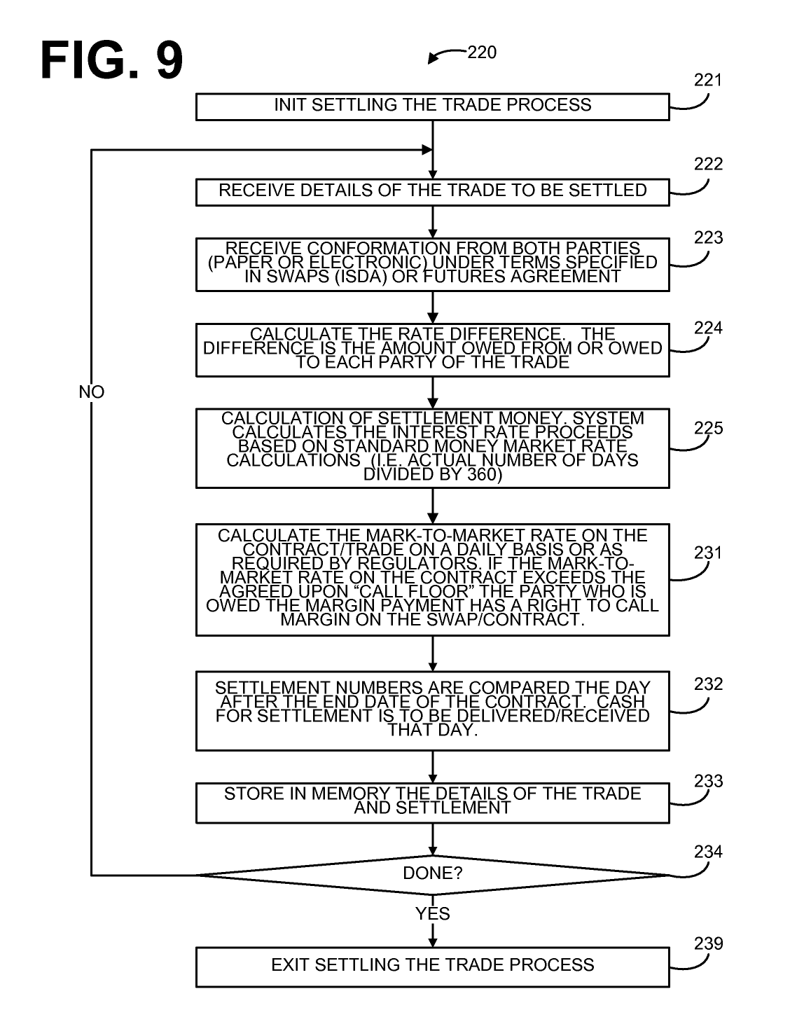

At step 115, it is determined if the action is a settling the trade action. If it is determined that the action is not a settling the trade action, then repo swap services system 100 skips to step 117. However, if it is determined in step 115 that the action is a settling the trade action, then repo swap services system 100 performs the settling the trade process at step 116. The settling the trade process is herein defined in further detail with regard to FIG. 9. After performing the settling the trade process, the repo swap services system 100 returns to step 102.

At step 117, it is determined if repo swap services system 100 is to wait for additional action request. If it is determined at step 117 that repo swap services system is to wait to receive additional actions, then repo swap services system 100 returns to repeat steps 102 through 117. However, if it is determined at step 117 that there are no more actions to be received, then repo swap services system 100 then exits at step 119.

FIG. 4 is a flow chart illustrating an example of the operation of the participant sign-in process 120 on the server 11 that is utilized in repo swap services system 100 of the present invention, as shown in FIGS. 2A-3. The participant sign-in process 120 can establish if the participant is to access the primary or a backup system running the repo swap services system 100 and then permit or deny a participant access to the repo swap services system 100 (FIG. 2A). A brief overview of one exemplary process is as follows: 1) determines if the primary computer host site houses software to run application; 2) if the primary computer is down, then it switches to back-up site; 3) participant logs into repo swap services system 100 with user name and password; 4) if login id is registered user, they are accepted into the system; 5) if attempted login is cancelled or doesn't exist, block participant's entry into system; 6) determining if participant wants to re-enter login and returning to repeat steps 3-6 if participant wants to re-enter login and 7) exiting if participant is registered user or if participant does not wants to re-enter login.

First at step 121, the participant sign-in process 120 is initialized. This initialization includes the startup routines and processes embedded in the BIOS of the server 11. The initialization also includes the establishment of data values for particular data structures utilized in the participant sign-in process 120.

At step 122, the participant sign-in process 120 determines if the primary computer host site houses software to run application. If it is determined at step 122 that the primary system is operable, then the participants sign in process 120 skips to step 124. However, if it is determined that the primary computer is down, then participant sign-in process 120 switches to back-up site at step 123.

At step 124, the participant logs into repo swap services system 100 with user name and password. At step 131, it is determined if the ID and password is for a registered user. If login id is registered user, the participant is accepted into the system at step 132. The participant sign-in process then skips to step 134. However, if it is determined at step 131 that the attempted login is cancelled or doesn't exist, then the participant sign-in process 120 blocks the participant's entry into system at step 133.

At step 134, the participant sign-in process 120 determines if participant wants to re-enter login. If it is determined that the participant does wish to reenter the login information, then the participant sign-in process 120 returns to repeat steps 125-134. However, if it is determined that the participant does not want to re-enter login, then the participant sign-in process 120) exits at step 139.

FIG. 5 is a flow chart illustrating an example of the operation of the display details of the market process 140 on the server that is utilized in repo swap services system 100 of the present invention, as shown in FIGS. 2A-3. The display details of the market process 140 can establish or modify customer specific information residing on database 12 (FIG. 2A). Once the new customer information is placed in server 11, it is available for customer parking reservations. A brief overview of one exemplary process is as follows: 1) Display markets that specify the underlying instruments; 2) traders/participants select markets to review; 3) Display selected markets; 4) D will determine if the broker average market (i.e. BAM) rates are calculated, and calculate the current day's BAM rates if they are not; 5) Display the current day's BAM rates and past barn rates; 6) determine if there are more markets to review and return to repeat steps 2-5 if there are more markets to review; and 7) done.

First at step 141, the display details of the market process 140 is initialized. This initialization includes the startup routines and processes embedded in the BIOS of the server 11. The initialization also includes the establishment of data values for particular data structures utilized in the display details of the market process 140.

At step 142, the display details of the market process 140 displays the markets that specify the underlying instruments. At step 143, the traders/participants are prompted to select markets to review. These instruments include, but is not limited to, General Collateral (all variations traded in the repo market including General Collateral Bonds, General Collateral Notes/Bills, etc.), treasury bill collateral, GCF, specific securities [i.e. U.S. Treasury 10 year note, or any specific U.S. Treasury security like the 2.625% Nov. 15, 2020], agency collateral, any specific agency securities (Fannie Mae, Freddie Mac), Agency mortgage back securities collateral, any specific agency mortgage backed securities, corporate bond investment grade collateral, any specific corporate bond, asset backed securities collateral, any specific asset backed security, stocks/equities, and the like. The underlying instrument can also be any index based U.S. Treasury specific securities or collateral, agencies, agency MBS, corporate bonds, equities and the like.

At step 144, the display details of the market process 140 displays instruments in each of the selected markets. The display of the instrument specifics of contract in each selected market includes, but is not limited to, name of contract, underlying instrument (collateral), settlement (start-date), end-date (i.e. the contract can begin cash settle (same day or term), regular settlement (next business day, or t+1), skip or spot settle (2^{nd} business day or t+2), Settlement day (starting day) terms are specified on the display).

At step 145, it is determined if the broker average market (i.e. BAM) rates are calculated. If it is determined at step 145 that the current day's BAM rates are calculated, then the display details of the market process 140 skips to step 152. However, if is determined that the broker average market (i.e. BAM) rates are not calculated, then the current day's BAM rates are calculated. The display details of the market process 140 performs the calculate broker average process at step 151. The calculate broker average process is herein defined in further detail with regard to FIG. 8.

At step 152, the current day's BAM rates and past BAM rates are displayed. The computer system may show past, historical BAM rates for existing trades. For example, if there is a 1 week trade done two days ago and there are 5 days left in the trade, the computer system may display the BAM rates for the first 2 days of the trade.

At step 152, it is determined if there are more markets to review. If it is determined at step 152 that there are more markets to review, then the display details of the market process 140 returns to repeat steps 143-153. However, if it is determined that the participant does not want review more markets, then the display details of the market process 140 exits at step 159.

FIG. 6 is a flow chart illustrating an example of the operation of the placing orders process 160 on the server that is utilized in repo swap services system 100 of the present invention, as shown in FIGS. 2A-3. The placing orders process 160 can track orders and only orders better than current market rates are accepted and displayed, orders behind the best bid or best offer are placed in the “market depth” or “stack” drop-down box. A brief overview of one exemplary process is as follows: 1) participants select which markets to enter orders; 2) participants display different columns on screen show bid-rate, offer-rate, bid-size, offer-size; 3) traders/participants place bids/offers for rates and size of the order, for specific contracts on remote device; 4) traders/participants orders are routed to the server; 5) then determined if the new offered order is greater than the existing order rate; 6) if it is determined that the new offered order is greater than the existing order rate, then the existing order rate is eliminated and the new offered order is displayed; 7) however, if it is determined that the new offered order is equal to or less than the existing order rate, then the new offered order is placed in the market stack; 8) it is then determined if the new bid order<existing bid order rate; 9) if it is determined that the new bid order is less than the existing bid order rate, then the existing bid order rate is eliminated and the new offered bid is displayed; 10) however, if it is determined that the new bid order is greater than or equal to the existing bid order rate, then the new bid order is placed in the market stack; 11) it is then determined that the best bid and/or offer was deleted and eliminating the best bid and/or offer and making the next bid and/or offer in the market depth the new best new bid and/or offer; 12) determining if the new bid and/or offer=a best bid and/or offer, and if so give to step 15; 13) determining if the new bid and/or offer=a leave order, and if so, display the best bid/offer and the market stacks; 14) determining that new bid and/or offer≠a leave order, and display “error, only the best markets are displayed” and, display the best bid and offer; 15) determining if participant wants to place bids/offers and returning to repeat steps 1-15 if participant wants to place bids/offers and 16) exiting if participant does not want to place more bids/offers. Some computer trading systems/markets might display a “stack” of trades, which are placed behind the best bid or best offer in the market. Some market participants may “leave orders” off the market (above the market or below the market) in anticipating having the trade done/executed when/if the market moves to their level.

First at step 161, the placing orders process 160 is initialized. This initialization includes the startup routines and processes embedded in the BIOS of the server 11. The initialization also includes the establishment of data values for particular data structures utilized in the placing orders process 160.

At step 162, the placing orders process 160 enables participants to select which markets to enter orders. In one embodiment, the different markets are identified by icons on a display terminal. In other embodiments, the different markets are identified as line items on the display terminal. In still an alternative embodiment, the markets are identified by the traders/participant input. Next at step 162, participants display different columns on screen show bid-rate, offer-rate, bid-size, offer-size of the different contracts that are available.

At step 164, traders/participants are enabled to place bids/offers for rates and size of the order, for specific contracts on remote device. For the purposes of this invention disclosure, a “bid” means the participant is willing to do the equivalent of invest cash at fixed rate, borrow cash at floating rate, and an “offer” means the participant is willing to do the equivalent of borrow cash at a fixed rate, and invest cash at a floating rate. At step 165, all traders/participants orders are routed to the server 11 (FIG. 2A).

At step 166, it is determined if the new offered order is greater than the existing order rate. If it is determined that the new offered order is greater than the existing order rate, then the existing order rate is eliminated and the new offered order is displayed at step 167. The placing orders process 160 then skips to step 169. However, if it is determined at step 166 that the new offered order is equal to or less than the existing order rate, then the new offered order is placed in the market stack at step 168.

At step 169, it is then determined if the new bid order<existing bid order rate. If it is determined that the new bid order is less than the existing bid order rate, then the existing bid order rate is eliminated and the new offered bid is displayed at step 170. The placing orders process 160 then skips to step 172. However, if it is determined at step 169 that the new bid order is greater than or equal to the existing bid order rate, then the new bid order is placed in the market stack at step 171.

At step 172, it is determined if the best bid and/or offer was deleted. If it is determined that the best bid and/or offer was not deleted, then the placing order process 160 then skips to step 174. However, if it is determined at step 172 that the best bid and/or offer was deleted, then the best bid and/or offer is eliminated and the next bid and/or offer in the market depth is made the new best new bid and/or offer.

At step 174, it is determined if the new bid and/or offer is equal to the best bid and/or offer. If it is determined at step 174 that the new bids and/or offer was the best bid and/or offer, then the placing order process 160 skips to step 178. However, if it is determined that the new bid and/or offer is not equal to the best bid and/or offer, then it is determined if the new bid and/or offer equal to leave order. If it is determined that the new bid and/or offer is equal to a leave order, then the placing order process 160 displays the best bid and offer and the market stacks. The placing order process 160 skips to step 178. However, if it is determined that the new bid and/or offer not equal to a leave order, then the remote device terminal 56 displays the following messages “error, only the best markets are displayed” and the best bid and offer. A “stack” is orders that are not the best orders in the market. The buy orders are lower than the highest bid and the sell orders are higher than the lowest sale price. Traders and investors leave (input) orders off the market because the expect the market to move and their orders to executed at their level. It is called a “stacked” because on a computer based trading screen, the orders are stacked behind the best bid or best offer.

At step 178, it is determined if participant wants to place bids/offers. If it is determined at step 178 that the participant does wish to place additional bids/offers, then the placing orders process 160 returns to repeat steps 162-178. However, if it is determined that the participant does not wish to place additional bids/offers, then the placing orders process 160 exits at step 179.

FIG. 7 is a flow chart illustrating an example of the operation of the orders match process 180 on the server that is utilized in repo swap services system 100 of the present invention, as shown in FIGS. 2A-3. The orders match process 180 can match bid and offers for a contract, calculates the terms of the trade and stores the details of the trade in memory residing on database 12 (FIG. 2A). A brief overview of one exemplary process is as follows: 1) Get first/next market to review; 2) determine if the bid rate matches the offer rate on the same market contract, and if not return to step 1; 3) if the bid rate matches the offer rate on the same market contract, calculate difference between start-date and the end-date; 4) calculate terms of the trade; 5) system automatically send a notification to each counter party of what they did in the trade; 6) system sends screen blinks of the rate to every remote device for 1 minute; 7) after 1 minute trade flash, system displays the best bid and best offer in the stack, including corresponding size amounts; 8) determine if the current bam rates are calculated, and skip to step 10 if so; 9) if the current BAM rates are not calculated, calculate current BAM rates; 10) store in memory the details of the trade; 11) determine if there are more orders to be matched and return to repeat steps 1-11 if there are more orders to be matched; and 12) done.

First at step 181, the orders match process 180 is initialized. This initialization includes the startup routines and processes embedded in the BIOS of the server 11. The initialization also includes the establishment of data values for particular data structures utilized in the orders match process 180.

At step 182, the orders match process 180 gets first/next market to review. These markets include, but is not limited to, General Collateral (all variations traded in the repo market including General Collateral Bonds, General Collateral Notes/Bills, etc.), treasury bill collateral, GCF, specific securities [i.e. U.S. Treasury 10 year note, or any specific U.S. Treasury security like the 2.625% Nov. 15, 2020], agency collateral, any specific agency securities (Fannie Mae, Freddie Mac), Agency mortgage back securities collateral, any specific agency mortgage backed securities, corporate bond investment grade collateral, any specific corporate bond, asset backed securities collateral, any specific asset backed security, stocks/equities, and the like. The underlying markets instrument can also be any index based U.S. Treasury specific securities or collateral, agencys, agency MBS, corporate bonds, equities and the like.

At step 183, the orders match process 180 determines if the bid rate matches the offer rate on the same market contract. If the bid rate does not match the offer rate on the same market contract, then the orders match process 180 returns to step 182. However, if the bid rate matches the offer rate on the same market contract, then the orders match process 180 calculates the difference between start-date and the end-date.

At step 185, the orders match process 180 calculating terms of the trade. The terms include, but are not limited to, a fixed rate and the floating rate for the trade. The fixed rate is the same for the whole life of the trade. The floating rate is determined daily, but it can be a negotiated rate for the day or an average of the daily rates based on actual trades. At step 186, the orders match process 180 automatically sends a notification to each counter party of what they did in the trade. At step 191, the orders match process 180 sends screen blinks of the rate to every remote device for 1 minute. After 1 minute trade flashing, the orders match process 180 displays at step 192 the best bid and best offer in the stack, including corresponding size amounts.

At step 193, the orders match process 180 determines if the current broker average market rate (the floating rate) has been calculated for the current day. If it is determined at step 193 that the current broker average market (i.e. BAM) rate has been calculated, then the orders match process 180 skips to step 195. However, if it is determined at step 193 that the current broker average market rate has not been calculated, then the orders match process calculates the current bam rate at step 194. The process to calculate the BAM rate is herein defined in further detail with regard to FIG. 8.

At step 195, the orders match process 180 stores the details of the trade in memory. Details of the trade include, but is not limited to, name of contract, underlying instrument (collateral), settlement (start-date), end-date (i.e. the contract can begin cash settle (same day or term), regular settlement (next business day, or t+1), skip or spot settle (2^{nd} business day or t+2), Settlement day (starting day) terms, and the fixed rate and floating rate (i.e. BAM) for the trade.

At step 196, it is determined if there are more orders to be matched. If it is determined at step 196 that there are more orders to be matched, then the orders match process 180 returns to repeat steps 182-196. However, if it is determined that there are no more orders to be matched, then the orders match process 180 exits at step 199.

FIG. 8 is a flow chart illustrating an example of the operation of the calculate broker average rate process 200 on the server 11 that is utilized in repo swap services system 100 of the present invention, as shown in FIGS. 2A-3. The calculate broker average rate process 200 calculates the daily BAM (floating) repo rate, calculates the final average rate as the sum of the weighted averages divided by the total volume for the current day, and stores the details of the trade in memory residing on database 12 (FIG. 2A). A brief overview of one exemplary process is as follows: 1) Accept a data feed or individual input of average daily rate or a weighted average of the IDB brokers' averages. Repo swap/cfd/futures can be based on any floating rate; 2) calculates the daily BAM (floating) repo rate; 3) the average(s) are weighted to get total weighted average from input sources; 4) calculates the final average is the sum of the weighted averages divided by the total volume for the current day, for past 5 working days, each day for past month, each day for past 3 months and each day for past year; 5) stores in memory the calculated BAM rates; 6) displays the calculated BAM rates; 7) determines if there are more BAM rates to be calculated and return to repeat steps 1-7 if there are more rates to be calculated; and 8) done.

First at step 201, the calculate broker average rate process 200 is initialized. This initialization includes the startup routines and processes embedded in the BIOS of the server 11. The initialization also includes the establishment of data values for particular data structures utilized in the calculate broker average rate process 200.

At step 202, the calculate broker average rate process 200 accepts a data feed or individual input of average daily rate or a weighted average of the IDB brokers' averages. Repo swap/CFD/futures can be based on any floating rate. At step 203, the calculate broker average rate process 200 calculates the daily BAM (floating) repo rate. The average for the day can be based on multiple sources, using a weighted average based on trading volumes.

At step 204, the average(s) are weighted to get total weighted average from input sources. Weighted average is average rate adjusted from volume traded on IDB brokers markets. At step 205, the calculate broker average rate process 200 calculates the final average is the sum of the weighted averages divided by the total volume for the current day, each day for past 5 working day, each day for past month, each day for past 3 months and each day for past year.

At step 211, the calculate broker average rate process 200 stores the calculated BAM rates in memory (12 and 42). At step 212, the calculated BAM rates are displayed on all remote devices 15.

At step 213, it is determined if there are more BAM rates to be calculated. If it is determined at step 213 that there are more BAM rates to be calculated, then the calculate broker average rate process 200 returns to repeat steps 203-213. However, if it is determined that there are no more BAM rates to be calculated, then the calculate broker average rate process 200 exits at step 219.

FIG. 9 is a flow chart illustrating an example of the operation of the settling the trade process 220 on the server 11 that is utilized in repo swap services system 100 of the present invention, as shown in FIGS. 2A-3. The settling the trade process 220 calculates the settlement numbers for the trade at the end of the contract, and stores the details of the trade in memory residing on database 12 (FIG. 2A). A brief overview of one exemplary process is as follows: 1) Receive details of the trade to be settled; 2) receive conformation from both parties (paper or electronic) under terms specified in swaps (isda) or futures agreement; 3) calculate the rate difference; 4) calculation of settlement money; 5) calculate the interest rate proceeds based on standard money market rate calculations (i.e. actual number of days divided by 360); 6) calculate the mark-to-market rate on the contract/trade on a daily basis or as required by regulators; 7) compare settlement numbers the day after the end date of the contract and cash for settlement is to be delivered/received that day; 8) store in memory the details of the trade and settlement; 9) determine if there are more trades to be settled and return to repeat steps 1-9 if there are more trades to be settled; and 8) done.

First at step 201, the settling the trade process 220 is initialized. This initialization includes the startup routines and processes embedded in the BIOS of the server 11. The initialization also includes the establishment of data values for particular data structures utilized in the settling the trade process 220.

At step 222, the settling the trade process 220 receives details of the trade to be settled. At step 223, the settling trade process 220 receives conformation from both parties (paper or electronic) under terms specified in repo (MRA), swaps (ISDA) or futures agreement. At step 224, the rate difference is calculated. The difference is the amount owed from or owed to each party of the trade. Once the rate difference is calculated, then the settling the trade process 220 calculates the settlement money at step 225. The settling the trade process 220 calculates the interest rate proceeds based on standard money market rate calculations (i.e. actual number of days divided by 360).

At step 231, the settling the trade process 220 calculates the mark-to-market rate on the contract/trade on a daily basis or as required by regulators. If the mark-to-market rate on the contract exceeds the agreed upon “call floor” the party who is owed the margin payment has a right to call margin on the swap/contract. At step 232, the settlement numbers are compared the day after the end date of the contract. Cash for settlement is to be delivered/received that day.

At step 233, the settling the trade process 220 stores in memory the details of the trade. The trade details include, but are not limited to, the fixed rate, floating rate, rate difference, amount of settlement money, number of days of the trade, mark to market rate, the call floor, any margin payment and the like.

At step 234, it is determined if there are more trades to be settled. If it is determined at step 234 that there are more trades to be settled, then the settling the trade process 220 returns to repeat steps 222-234. However, if it is determined that there are no more trades to be settled, then the settling the trade process 220 exits at step 239.

In an alternative embodiment, the repo swap system, calculations and technology can be integrated into existing trading, execution, trade process, clearing and settlement software and systems.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method of conducting a REPO SWAP/CFD financial transaction on an electronic trading system embodied in a computer program product for execution on an instruction processing system, comprising a tangible storage medium readable by the instruction processing system and storing instructions for execution by the instruction processing system for performing the method comprising:
using the instruction processing system to identify a fixed rate for a repo market transaction;
identifying by the instruction processing system a variable rate for a repo market transaction, the variable rate derived from a weighted average of collateralized trades in the repo market;
calculating by the instruction processing system a difference between the fixed rate and the variable rate using the at least one computer processor; and
outputting data for display on a user interface from the at least one computer processor representing an amount to be exchanged based on the determined difference by the instruction processing system, between parties to the transaction.

2. The method of claim 1, wherein the fixed rate is based on a fixed term rate for a stated period and the weighted average of collateralized trades variable rate is based on a daily average floating rate for the stated period.

3. The method of claim 1, wherein the weighted average of collateralized trades variable rate is based on a quarterly average floating rate.

4. The method of claim 1, wherein the weighted average of collateralized trades variable rate is based on a monthly average floating rate.

5. The method of claim 1, wherein the weighted average of collateralized trades variable rate is determined based on a weighted average of at least one broker daily average.

6. The method of claim 1, further comprising executing a SWAP/CFD agreement between the parties to the transaction specifying terms of the transaction.

7. The method of claim 1, wherein the repo market transaction is based on an underlying security selected from General Collateral Bonds, General Collateral Notes, General Collateral Bills, treasury bill collateral, GCF, U.S. Treasury note, agency collateral, Fannie Mae securities, Freddie Mac securities, Agency mortgage back securities collateral, mortgage backed securities, corporate bond investment grade collateral, asset backed securities collateral, any specific asset backed security, stocks and equities.

8. The method of claim 1, further comprising initiating an exchange of funds over the electronic trading system in the calculated amount to be exchanged.

9. A method of conducting a REPO SWAP/CFD financial transaction embodied in a computer program product for execution on an instruction processing system, comprising a tangible storage medium readable by the instruction processing system and storing instructions for execution by the instruction processing system for performing the method comprising:
the instruction processing system
receiving input data representing at least one fixed rate for collateralized trades on a repo market versus and at least one floating rate for collateralized trades on a repo market swap instrument in the repo market into the instruction processing system;
processing the data using the instruction processing system to determine a weighted market average floating rate for collateralized trades on the repo market and establish a swap between floating and fixed rate repo markets; and
outputting a result from the instruction processing system to a user interface representing the established swap.

10. The method of claim 9, wherein the weighted market average floating rate is based on one or more daily broker averages.

11. An electronic trading system for conducting a REPO SWAP/CFD transaction, said system comprising:
a tangible storage medium readable by the computer system and storing instructions for execution at least one computer processor; and
a subsystem executed by the at least one computer processor for establishing a contract to pay the difference between a fixed rate for collateralized trades on a repo market and an a weighted market average of floating rates for collateralized trades on the repo market for life of a trade, and outputting data representing the established contract to a user interface.

12. The system of claim 11, further comprising a second subsystem executed by the at least one computer processor for establishing a market for trading the contract between parties.

13. An electronic trading system for conducting a plurality of SWAP/CFD transactions, the electronic trading system comprising:
a tangible storage medium readable by the computer system and storing instructions for execution at least one computer processor; and
a subsystem executed by the at least one computer processor to establish an online network for identifying cash flows and contract rates of at least one SWAP/CFD transaction, based on a fixed rate for collateralized trades in the repo market and a weighted market average of floating rates for collateralized trades in the repo market, and outputting data representing the cash flows and contract rates to a user interface.

14. An electronic trading system for determining a value of a financial instrument comprising a repo market SWAP/CFD, the electronic trading system comprising:
a tangible storage medium readable by the computer system and storing instructions for execution at least one computer processor; and
a subsystem executed by the at least one computer processor for determining a value of a financial instrument comprising a repo market SWAP/CFD, and providing a return based on a differential between a fixed term repo rate for collateralized trades in the repo market and a weighted market average floating repo rate for collateralized trades in the repo market, and outputting data representing the value of the financial instrument to a user interface.

15. An electronic trading system for determining a value of a financial instrument, the electronic trading system comprising:
a tangible storage medium readable by the computer system and storing instructions for execution at least one computer processor; and
a subsystem executed by the at least one computer processor to determine a value based on a difference between a fixed value amount for a collateralized trade in the repo market for a repo market transaction and a weighted market average variable value amount for a collateralized trade in the repo market for a repo market transaction, and outputting data representing the determined value to a user interface.

16. An electronic trading system for determining a value of a financial instrument comprising a derivative based on a repo market transaction on a computer system, comprising:
a tangible storage medium readable by the computer system and storing instructions for execution by the computer system;
a subsystem executed by the computer system further comprising:
means for determining a value of a financial instrument comprising a derivative based on a collateralized transaction in the repo market transaction; and
means for outputting data representing the determined value to a user interface.
